(19) United States
(12) Patent Application Publication
(10) Pub. No.: US 2020/0019108 A1
(43) Pub. Date: Jan. 16, 2020

(54) IMAGE FORMING DEVICE AND MISALIGNMENT CORRECTION METHOD

(71) Applicant: KONICA MINOLTA, INC., Tokyo (JP)

(72) Inventors: Hidenori MINE, Tokyo (JP); Kenji IZUMIYA, Tokyo (JP); Keigo OGURA, Tokyo (JP); Takumi SHIRAKUMA, Tokyo (JP); Hirokatsu KODAMA, Tokyo (JP)

(73) Assignee: KONICA MINOLTA, INC., Tokyo (JP)

(21) Appl. No.: 16/460,695

(22) Filed: Jul. 2, 2019

(30) Foreign Application Priority Data
Jul. 13, 2018 (JP) 2018-132841

(51) Int. Cl. G03G 15/00

(52) U.S. Cl. CPC G03G 15/6561

(57) ABSTRACT

An image forming device includes a resist roller feeding a sheet of paper toward an image forming unit; a first detector arranged upstream of the resist roller in a feeding direction to detect a front edge of the sheet of paper; a first calculator computing a first misalignment amount of the sheet of paper based on detection results by the first detector; a corrector correcting misalignment of the sheet of paper based on the computed first misalignment amount; a second detector arranged downstream of the resist roller in the feeding direction to detect a position of an end of the sheet of paper in a widthwise direction; a second calculator computing a second misalignment amount of the sheet of paper based on detection results by the second detector; and an adjuster adjusting a correction amount by the corrector based on the computed second misalignment amount.

### BACKGROUND

### Technological Field

The present invention relates to an image forming device and a misalignment correction method.

### Description of the Related Art

Traditionally, an existing electrophotographic image forming device develops an electrostatic latent image formed on a photoreceptor with toner to form a toner image, and transfers the formed toner image to a sheet of paper to heat and fix the transferred toner image.

In the above-described image forming device, a resist roller is arranged immediately before a transfer roller that transfers the toner image to the sheet of paper. After the front edge of the sheet of paper abuts on a nip line of the resist roller, the sheet of paper is fed for a predetermined period of time by a pair of loop rollers or the like arranged immediately before the resist roller, and thus a loop (resist loop) is formed in the sheet of paper.

Given the above-described features, a configuration is disclosed in which a detection feature is included for detecting a side edge of a sheet of paper to detect a misalignment (an amount of deviation) in a widthwise direction of the sheet of paper (main scan direction) and the misalignment of the sheet of paper in the widthwise direction is corrected by moving a resist roller in the widthwise direction on the basis of a signal corresponding to the misalignment from the detection feature (for example, see Japanese Patent Application Laid-Open Nos. 2000-280554 and H11-189355).

Also, another configuration is known according to which pair of misalignment sensors that detect an amount of misalignment of a sheet of paper on the basis of difference in the times of passage of the sheet of paper is arranged between a pair of loop rollers and a resist roller. According to the above-sketched configuration, it is made possible to correct the misalignment of the sheet of paper by individually and independently controlling the feed speed of the pair of loop rollers on the basis of the amount of misalignment that has been detected by the pair of misalignment sensors (independent misalignment correction) and thereby improve the accuracy of the positions of images.

### SUMMARY

In recent years, the range of the thickness of the sheet of paper to be fed (paper thickness) as well as the range of the stiffness have been becoming larger corresponding to the development and diversification of the market demands. In particular, a sheet of paper such as a cardboard with a high stiffness involves a high slip torque, making it difficult to create a proper loop. Also, a sheet of paper with a high stiffness often causes misalignment due to the sliding resistance of the upstream feed rollers sandwiching and holding the rear edge of the sheet of paper. Further, in the case of coat paper or thin paper, the misalignment correction amount tends to be insufficient due to temporal change or stains on the upstream feed roller. As a result of these impacts, a problem arises that the misalignment correction amount becomes insufficient at the time of re-feeding by the resist roller (in other words, the misalignment correction is insufficient).

As mentioned above, insufficiencies in the misalignment correction amount lead to degradation of the accuracy of positions of images on the front and back sides of the sheet of paper. Also, an insufficient misalignment correction amount causes a deviation sensor arranged downstream of the resist roller to erroneously detect a side edge of a sheet of paper at the time of the resist oscillation correction to correct the amount of deviation in the main scan direction, which leads to resist oscillation to take place in accordance with an improper amount of deviation, which in turn leads to creation of wrinkles in the paper or transfer errors.

An object of the present invention is to provide an image forming device and a misalignment correction method capable of suppressing degradation of accuracy of the positions of images and poor images and improving quality of images.

To achieve at least one of the abovementioned objects, according to a first aspect of the present invention, an image forming device reflecting one aspect of the present invention is an image forming device including an image forming unit that forms an image on a sheet of paper, the image forming device comprising

a resist roller that feeds the sheet of paper toward the image forming unit; a first detector that detects a front edge of the sheet of paper, the first detector being arranged upstream of the resist roller in a paper feed direction; a first calculator that computes a first amount of misalignment of the sheet of paper on the basis of a result of detection by the first detector; a corrector that corrects misalignment of the sheet of paper on the basis of the first amount of misalignment computed by the first calculator; a second detector that detects a position of an end of the sheet of paper in a widthwise direction parallel to a width of the sheet of paper, the second detector being arranged downstream of the resist roller in the paper feed direction; a second calculator that computes a second amount of misalignment of the sheet of paper on the basis of a result of detection by the second detector; and an adjuster that adjusts an amount of correction by the corrector on the basis of the second amount of misalignment computed by the second calculator.

According to a second aspect of the present invention, a misalignment correction method reflecting one aspect of the present invention is a misalignment correction method in an image forming device including an image forming unit forming an image on a sheet of paper, the method comprising

computing a first amount of misalignment of the sheet of paper on the basis of a result of detection by a first detector that is arranged upstream of a resist roller feeding the sheet of paper toward the image forming unit in a paper feed direction and detects a front edge of the sheet of paper; correcting misalignment of the sheet of paper on the basis of the computed first amount of misalignment; computing a second amount of misalignment of the sheet of paper on the basis of a result of detection by a second detector that is arranged downstream of the resist roller in the paper feed direction and detects a position of an end of the sheet of paper in the widthwise direction; and adjusting an amount of correction of the misalignment of the sheet of paper on the basis of the computed second amount of misalignment.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a front view illustrating a schematic configuration of an image forming device in accordance with an embodiment;

FIG. 2 is a functional block diagram illustrating a control structure of the image forming device according to the embodiment;

FIG. 3 is a plan view illustrating a configuration of a resist unit;

FIG. 4 is a diagram showing a flowchart that illustrates operation of the image forming device G in accordance with the embodiment;

FIG. 5 is a diagram illustrating an example of a state where a front edge of a sheet of paper is detected by one of a pair of misalignment sensors;

FIG. 6 is a diagram illustrating an example of a state where a front edge of the sheet of paper is detected by the other of the pair of misalignment sensors;

FIG. 7 is a diagram illustrating an example of a state where misalignment of a sheet of paper is corrected by a pair of loop rollers;

FIGS. 8A and 8B are diagrams illustrating an example of a state where a position of an end of the sheet of paper in its widthwise direction is detected at predetermined intervals by a deviation sensor;

FIG. 9 is a diagram that explains a method of computing an amount of misalignment and skew of a sheet of paper prior to the sheet of paper coming into contact with and abutment on the resist roller; and

FIG. 10 is a diagram that explains a method of computing a range where actual oscillations can take place after the front edge of the sheet of paper having passed the resist roller.

### DETAILED DESCRIPTION OF EMBODIMENTS

Hereinafter, one or more embodiments of the present invention will be described with reference to the drawings. However, the scope of the invention is not limited to the disclosed embodiments.

Hence, the details of the embodiments of the present invention, which are shown and described by way of illustration and in no way intended to be considered limiting, will be provided hereinbelow with reference to the accompanying drawings.

An image forming device G in accordance with this embodiment is a tandem color image forming device that forms a color image on a sheet of paper by electrophotography on the basis of image data obtained by reading an image from a document or image data received from an external device.

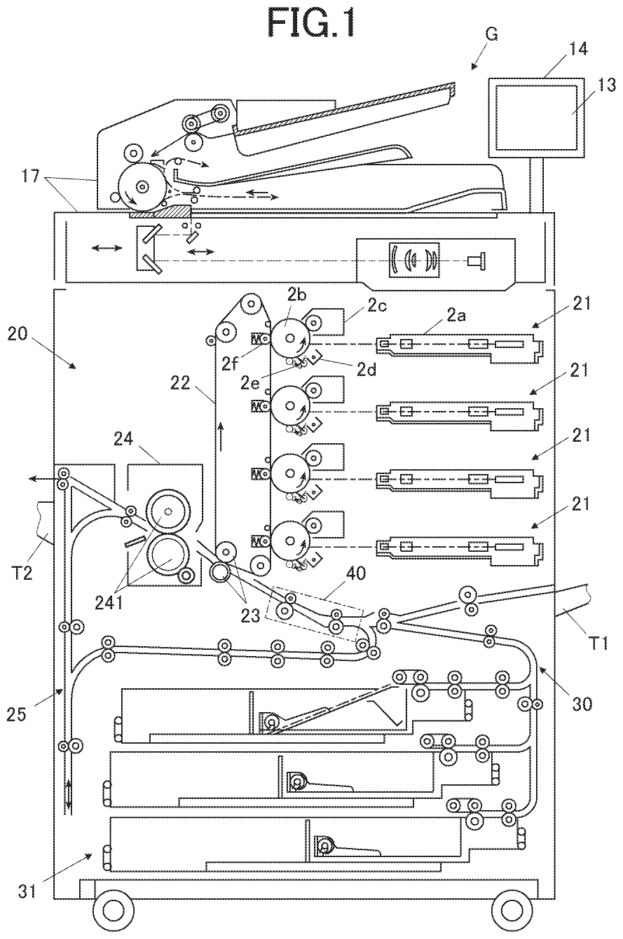

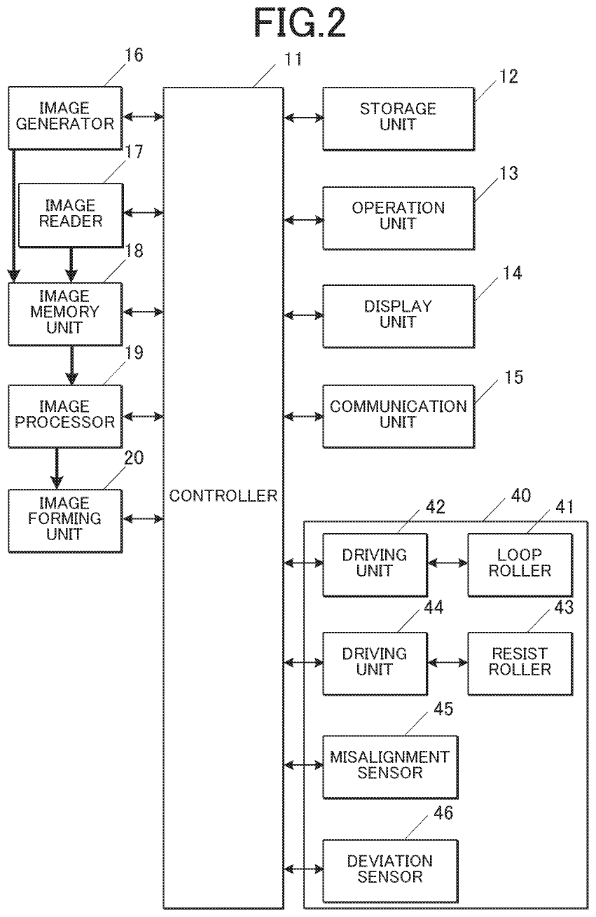

Referring to FIGS. 1 and 2, the image forming device G includes, as its constituent components, a controller 11, a storage unit 12, an operation unit 13, a display unit 14, a communication unit 15, an image generator 16, an image reader 17, an image memory unit 18, an image processor 19, an image forming unit 20, and a conveyor 30.

The controller 11 includes a CPU, a RAM unit, etc. The CPU reads various processing programs stored in the storage unit 12 in accordance with operation signal input from the operation unit 13 or a command signal received from the communication unit 15 to deploy them onto the RAM unit, and controls the operations of the individual units of the image forming device G in a centralized manner in accordance with the programs that have been deployed.

For example, the controller 11 causes the image processor 19 to perform image processing on an original image generated by the image generator 16 or the image reader 17 and held in the image memory unit 18 and causes the image forming unit 20 to form an image on a sheet of paper on the basis of the original image that has been subjected to the image processing.

The storage unit 12 stores programs that can be read by the controller 11, files used in execution of the programs, and the like. As the storage unit 12, a large capacity memory unit such as a hard disk can be used.

Also, the storage unit 12 stores an amount of misalignment M2 of the sheet of paper that has been computed on the basis of a result of detection by the deviation sensor 46.

The operation unit 13 and the display unit 14 are provided on the upper portion of the image forming device G as a user interface as illustrated in FIG. 1.

The operation unit 13 generates an operation signal in accordance with an operation by a user and outputs the operation signal to the controller 11. As the operation unit 13, a keypad, a touch panel configured in one piece with the display unit 14, and the like can be used.

The display unit 14 displays an operation screen and the like in accordance with the instruction by the controller 11. As the display unit 14, a liquid crystal display (LCD), an organic electro luminescence display (OELD), and the like can be used.

The communication unit 15 communicates with external devices in a network, such as user terminals, servers, other imaging systems, etc.

The communication unit 15 receives vector data in which content of the instruction to form an image is described using a page description language (PDL) from a user terminal via the network.

The image generator 16 subjects the vector data received from the communication unit 15 to a rasterization process and generates a bitmap original image. The original image has pixels each of which has pixel values of four colors including cyan (C), magenta (M), yellow (Y) and black (K). A pixel value is a data value representing the lightness and darkness of the image and, for example, a data value of eight (8) bits represents lightness and darkness of 0 to 255 gradations.

The image reader 17 includes an automatic document feeder device, a scanner, etc. as illustrated in FIG. 1, reads the surface of the document placed on a document table, and generates a bitmap original image. The original image that has been generated by the image reader 17 has pixels each of which has pixel values of three colors including red (R), green (G), and blue (B). The original image is color-converted to an original image having pixel values of four colors of C, M, Y, and K by a not-shown color converter.

The image memory unit 18 is a buffer memory unit that temporarily holds the original image generated by the image generator 16 or the image reader 17. As the image memory unit 18, dynamic RAM (DRAM) and the like can be used.

The image processor 19 reads the original image from the image memory unit 18 to perform various processes of image processing such as density correction processing and halftone processing.

The density correction processing is a process of converting the pixel values of the pixels of the original image into pixel values corrected such that the density of the image formed on the sheet of paper is in agreement with an objective or target density.

The halftone processing is a process for reproducing a halftone in a pseudo manner, which may include, for example, error diffusion processing, screen processing using ordered dithering, etc.

The image forming unit 20 forms an image including four colors of C, M, Y, and K on the sheet of paper in accordance with the pixel values of four colors of the pixels of the original image that has been subjected to the image processing by the image processor 19.

The image forming unit 20 includes four writing units 21, an intermediate transfer belt 22, a secondary transfer roller 23, a fusing device 24, and the like as illustrated in FIG. 1.

The four writing units 21 are arranged in series (tandem) along the belt surface of the intermediate transfer belt 22 so as to form an image having the colors of C, M, Y, and K. The writing units 21 have the same configuration while only differing from each other in their colors of the image to be formed and include, as their components, an optical scanning device 2a, a photoreceptor 2b, a developing unit 2c, a charging unit 2d, a cleaning unit 2e, and a primary transfer roller 2f as illustrated in FIG. 1.

In the image formation process, at each writing unit 21, after the photoreceptor 2b has been charged by the charging unit 2d, the surface of the photoreceptor 2b is scanned by the light beams emitted by the optical scanning device 2a on the basis of the original image, and an electrostatic latent image is formed. When the development is performed by the developing unit 2c supplying color material such as toner, an image is formed on the photoreceptor 2b.

The images formed on the photoreceptors 2b of the four writing units 21 are sequentially transferred on top of another upon the intermediate transfer belt 22 by their respective primary transfer rollers 2f (primary transfer). As a result of this, an image with the respective colors will be formed on the intermediate transfer belt 22. The intermediate transfer belt 22 is an image carrier which is wound around and rotated by a plurality of rollers. After the primary transfer, the color materials remaining on the photoreceptor 2b are removed by the cleaning unit 2e.

The image forming unit 20 feeds a sheet of paper from the manual feed tray T1 or the paper feed tray 31 when the image on the rotating intermediate transfer belt 22 has reached the position of the secondary transfer roller 23. The secondary transfer roller 23 has one of a pair of rollers in pressure contact with the intermediate transfer belt 22 and the other of the pair of rollers constitutes one of a plurality of rollers around which the intermediate transfer belt 22 is wound. When the image is transferred from the intermediate transfer belt 22 onto the sheet of paper by virtue of the pressure contact of the secondary transfer roller 23 (secondary transfer), the sheet of paper is fed to the fusing device 24 to subject the sheet of paper to the fusing process there, and then the sheet of paper is discharged into the paper discharge tray T2. The fusing process is a process of heating and pressing a sheet of paper by the fuser roller 241 to permanently fix the image on the sheet of paper. In a case where images should be formed on both sides of a sheet of paper, after the sheet of paper has been fed to the path of inversion 25 and the surfaces of the sheet of paper have been inverted, the same sheet of paper should be fed again to the position of the secondary transfer roller 23.

The conveyor 30, which includes a feed roller or the like for feeding a sheet of paper, feeds the sheets of papers stored in the paper feed tray 31 to the image forming unit 20 and conveys the sheets of papers within the image forming device G until the sheet of paper on which an image or images have been formed is discharged to the outside of the image forming device G. The conveyor 30 includes a resist unit 40 for adjusting the position of the image relative to the sheet of paper.

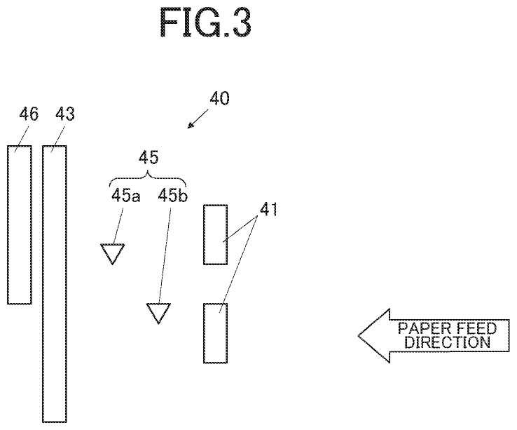

Referring to FIGS. 2 and 3, the resist unit 40 includes, as its components, a pair of loop rollers 41, a pair of driving units 42 individually and independently driving corresponding one of the pair of loop rollers 41, a resist roller 43, a driving unit 44 that drives the resist roller 43, a pair of misalignment sensors 45, a deviation sensor 46, and the like.

The loop rollers (feed roller) 41 is arranged upstream of the resist roller 43 (misalignment sensor 45) in the paper feed direction and, in a state where the driving of the resist roller 43 is stopped, makes a front edge of the sheet of paper abut on the resist nip section which is formed by bringing a pair of rollers constituting the resist roller 43 into pressing contact, and feeds forward the sheet of paper for a predetermined period of time, and thereby forms a loop (resist loop) in the sheet of paper.

Two loop rollers 41 and two driving units 42 are arranged in a direction orthogonal to the paper feed direction of the sheet of paper (widthwise direction parallel to the width of the sheet of paper). In this embodiment, one loop roller 41 and one driving unit 42 are arranged at a proximal side and at the distal side, respectively.

The controller 11 individually and independently controls the pair of driving units 42 to provide a difference between the feed speeds of the sheet of paper by the pair of loop rollers 41, and performs the misalignment correction process to correct the misalignment of the sheet of paper. Specifically, the controller 11 computes the amount of misalignment M1 of the sheet of paper on the basis of the result of detection by the pair of misalignment sensors 45, controls the driving units 42 on the basis of the computed amount of misalignment M1 such that the difference in the speed is created between the pair of loop rollers 41, and thereby performs the misalignment correction process on the sheet of paper.

The resist roller 43 is a roller for alignment of the position of the front edge of the sheet of paper, and conveys the sheet of paper toward the image forming unit 20 (secondary transfer roller 23). Also, the resist roller 43 is configured to be movable in the widthwise direction parallel to the width of the sheet of paper by a not-shown widthwise direction driving unit, and corrects the positional deviation of the sheet of paper in the widthwise direction.

The controller 11 computes the amount of deviation of the sheet of paper on the basis of the result of detection by the deviation sensor 46, and computes the amount of oscillation of the resist roller 43 on the basis of the computed amount of deviation. In addition, the controller 11 controls the not-shown widthwise direction driving unit on the basis of the computed amount of oscillation to cause the resist roller 43 to be oscillated in the widthwise direction parallel to the width of the sheet of paper, and performs the resist oscillation process to correct the positional deviation of the sheet of paper in the widthwise direction.

The misalignment sensor 45 is configured by a reflective sensor and detects passage of a front edge (or a rear edge) of the sheet of paper on the basis of the presence or absence of blocking of light by the sheet of paper fed on the feeding route. Two misalignment sensors 45 are arranged next to each other in the widthwise direction parallel to the width of the sheet of paper (main scan direction) and upstream of the resist roller 43 in the paper feed direction. That is, the misalignment sensor 45 functions as the first detector in accordance with the present invention. In this embodiment, one misalignment sensor 45 at the proximal side and another misalignment sensor 45 at the distal side are arranged in a state where they are displaced with reference to each other in the paper feed direction to feed the sheet of paper (in the example illustrated in FIG. 3, the distal-side misalignment sensor 45a is displaced with reference to the proximal-side misalignment sensor 45b to be downstream thereof in the paper feed direction). That is, in this embodiment, the expression “a pair of sensors arranged next to each other in a direction orthogonal to the paper feed direction (main scan direction)” is not intended to delimit the configuration to the one in which the pair of sensors are arranged to be orthogonal to the paper feed direction but envisages configurations in which the pair of sensors are arranged to be displaced relative to each other in the paper feed direction.

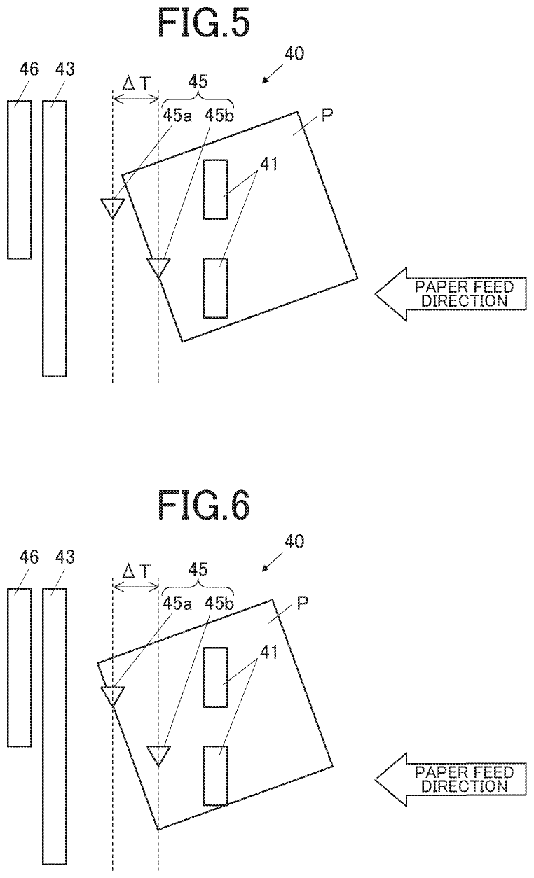

The controller 11 computes the amount of misalignment M1 of the sheet of paper on the basis of a difference ΔT (see FIGS. 5 and 6) in the times of passage of the sheet of paper that have been detected by the pair of misalignment sensors 45. Specifically, the controller 11 computes the amount of misalignment M1 of the sheet of paper on the basis of a difference ΔTr in the times of passage of the sheet of paper detected by the misalignment sensors 45 in an ideal state where no misalignment is observed in the sheet of paper and the difference ΔT in the times of passage of the sheet of paper that has been actually detected by the misalignment sensors 45.

The deviation sensor 46, which is configured by a line sensor, detects position of the one end of the sheet of paper in the widthwise direction on the basis of presence or absence of blocking of light by the sheet of paper that is being fed on the feeding route. The deviation sensor 46 is arranged downstream of the resist roller 43 in the paper feed direction. That is, the deviation sensor 46 functions as the second detector in accordance with the present invention. The controller 11 computes the amount of deviation of the sheet of paper that is being fed on the feeding route, i.e., the amount of positional deviation of the sheet of paper in the widthwise direction, on the basis of the position of the one end of the sheet of paper in the widthwise direction that has been detected by the deviation sensor 46.

Also, in this embodiment, the deviation sensor 46 detects positions of predetermined n points (n 2) of the one end of the sheet of paper in the widthwise direction that is fed on the feeding route. In this case, the controller 11 computes the amounts of deviation kcl (see FIG. 8A) to kcn (see FIG. 8B) of the positions of then points detected by the deviation sensor 46. After that, the controller 11 computes the amount of misalignment M2 of the sheet of paper on the basis of the amount of change in the computed amounts of deviation kcl to kcn.

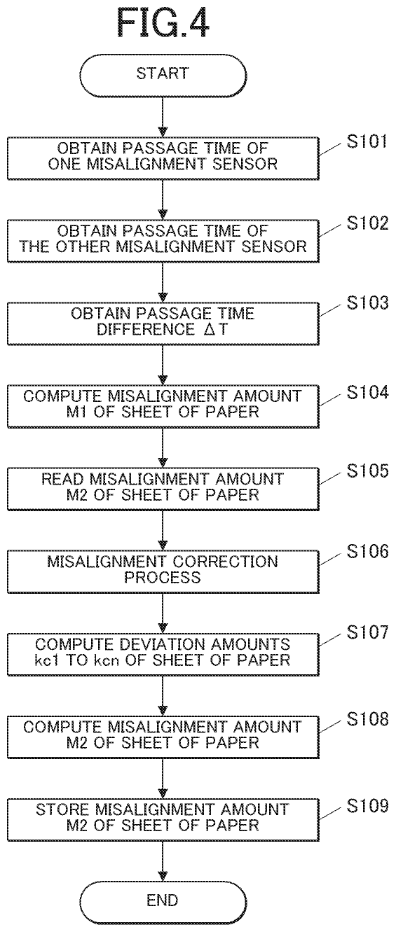

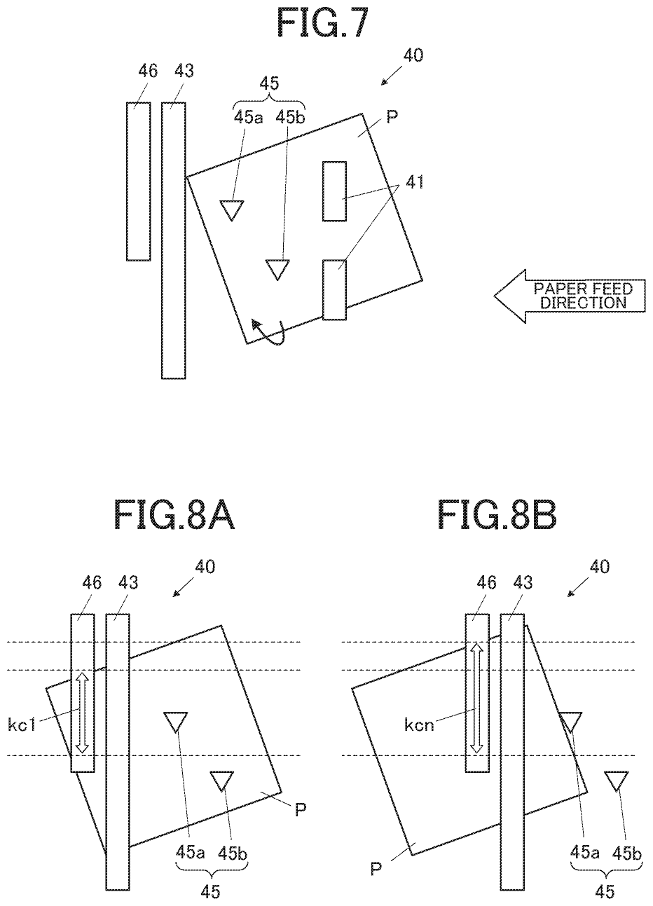

In the following paragraphs, the operation of the image forming device G in accordance with this embodiment will be described with reference to FIGS. 4 to 8. FIG. 4 shows the flowchart that illustrates the operation of the image forming device G in accordance with this embodiment. FIGS. 5 and 6 illustrate examples of a state where the front edge of the sheet of paper is detected by the pair of misalignment sensors 45. FIG. 7 illustrates an example of a state where the misalignment of the sheet of paper is corrected by the pair of loop rollers 41. FIG. 8 illustrates an example of a state where the position of the one end of the sheet of paper in the widthwise direction is detected by the deviation sensor 46 at predetermined intervals. It should be noted that the symbol P appearing in FIGS. 5 to 8 indicates the sheet of paper that is being fed.

First, the controller 11 obtains, as illustrated in FIG. 5, the time point at which the front edge of the sheet of paper is detected by one of the pair of misalignment sensors 45 (the time point at which the front edge of the sheet of paper passed one of the pair of misalignment sensors 45), i.e., the time of passage of one of the misalignment sensors 45 (the step S101).

Subsequently, the controller 11 obtains, as illustrated in FIG. 6, the time point at which the front edge of the sheet of paper is detected by the other of the pair of misalignment sensors 45 (the time point at which the front edge of the sheet of paper passed the other of the pair of misalignment sensors 45), i.e., the time of passage of the other misalignment sensor 45 (the step S102).

Subsequently, the controller 11 obtains the difference ΔT in the time of passage between the time of passage of the one misalignment sensor 45 obtained in the step S101 and the time of passage of the other misalignment sensor 45 obtained in the step S102 (the step S103). It should be noted that, in a case where the processes at the step S101 and the step S102 have been simultaneously performed (a case where the front edge of the sheet of paper has passed the pair of misalignment sensors 45 at the same time point), the difference ΔT of the time of passage will be zero.

Subsequently, the controller 11 computes the amount of misalignment M1 (first amount of misalignment) of the sheet of paper on the basis of the difference ΔT in the times of passage obtained in the step S103 and the difference ΔTr in the times of passage of the sheet of paper detected by the misalignment sensors 45 in an ideal state where no misalignment is observed in the sheet of paper (the step S104). That is, the controller 11 functions as the first calculator in accordance with the present invention.

Subsequently, the controller 11 reads the amount of misalignment M2 of the sheet of paper that has been computed on the basis of the result of detection by the deviation sensor 46 from the storage unit 12 (the step S105). It should be noted that the amount of misalignment M2 of the sheet of paper is computed in the step S108 at the time of the previous round of operation (at the time of the feeding of a previous sheet of paper, which may be the feeding of the sheet of paper of this round of operation in a case where a long sheet of paper is to be fed) and stored in the storage unit 12 in the step S109.

Subsequently, the controller 11 performs, as illustrated in FIG. 7, the misalignment correction process to correct the misalignment of the sheet of paper on the basis of the amount of misalignment M1 that has been computed in the step S104 and the amount of misalignment M2 that has been read in the step S105 (the step S106). That is, the controller 11 functions as the corrector in accordance with the present invention. Specifically, the controller 11 performs the misalignment correction process to correct the misalignment of the sheet of paper by controlling the driving unit 42 such that the pair of loop rollers 41 have the speed difference from each other on the basis of the value obtained by adding the amount of misalignment M1 that has been computed in the step S104 to the amount of misalignment M2 that has been read in the step S105.

Subsequently, the controller 11 computes, as illustrated in FIGS. 8A and 8B, the amounts of deviation kcl to kcn of the sheet of paper on the basis of the position of the one end of the sheet of paper in the widthwise direction detected by the deviation sensor 46 at predetermined intervals (the step S107). Specifically, the controller 11 computes the amounts of deviation kcl to ken of the sheet of paper on the basis of the positions of the predetermined n points of the one end of the sheet of paper in the widthwise direction that have been detected by the deviation sensor 46.

Subsequently, the controller 11 computes the amount of misalignment M2 of the sheet of paper (second amount of misalignment) on the basis of the amount of change in the amounts of deviation kcl to kcn that have been computed in the step S107 (the step S108). That is, the controller 11 functions as the second calculator in accordance with the present invention.

Subsequently, the controller 11 stores the amount of misalignment M2 of the sheet of paper computed in the step S108 in the storage unit 12 (the step S109). As a result of this, the amount of misalignment M2 of the sheet of paper is read from the storage unit 12 in the step S105 at the time of the next round of operation, and, the amount of correction of the misalignment of the sheet of paper is adjusted in the step S106 (specifically, the amount of misalignment M2 that has been read is added to the amount of misalignment M1 that has been computed in the step S104). That is, the controller 11 functions as the adjuster in accordance with the present invention. It should be noted that, if the amount of misalignment M2 of the sheet of paper is already stored in the storage unit 12, the amount of misalignment M2 is overwritten and stored.

As has been described in the foregoing, the image forming device G in accordance with this embodiment includes the resist roller 43 that feeds the sheet of paper toward the image forming unit 20, the first detector (misalignment sensor 45) arranged upstream of the resist roller 43 in the paper feed direction and configured to detect the front edge of the sheet of paper, the first calculator (controller 11) that computes the first amount of misalignment of the sheet of paper on the basis of the result of detection by the first detector, the corrector (controller 11) that corrects the misalignment of the sheet of paper on the basis of the first amount of misalignment that has been computed by the first calculator, the second detector (deviation sensor 46) arranged downstream of the resist roller 43 in the paper feed direction and configured to detect the position of the one end of the sheet of paper in the widthwise direction, the second calculator (controller 11) that computes the second amount of misalignment of the sheet of paper on the basis of the result of detection by the second detector, and the adjuster (controller 11) that adjusts the amount of correction by the corrector on the basis of the second amount of misalignment that has been computed by the second calculator.

Accordingly, since the image forming device G in accordance with this embodiment can correct the misalignment with the misalignment at the time of the re-feeding by the resist roller 43 taken into account, it is made possible to implement sufficient misalignment correction. Hence, it is made possible to suppress degradation of the accuracy of the positions of images and image errors and improve the image quality.

Also, in a case where a long sheet of paper should be fed, the result of the detection by the deviation sensor can be taken into account in real time at the time of the misalignment correction, so that degradation of the accuracy of the positions of images and image errors can be more reliably and effectively suppressed.

Also, according to the image forming device G in accordance with this embodiment, the corrector controls the pair of feed rollers (loop rollers 41) arranged next to each other in the direction orthogonal to the paper feed direction and arranged upstream of the first detector in the paper feed direction such that they have the speed difference and thereby corrects the misalignment of the sheet of paper.

Accordingly, since the image forming device G in accordance with this embodiment can correct the misalignment of the sheet of paper using a conventional feature without introducing a new feature, it is made possible to suppress increase in the size of the device and costs associated therewith.

Also, according to the image forming device G in accordance with this embodiment, the first detector has the pair of sensors (misalignment sensor 45a, 45b) arranged next to each other in a direction orthogonal to the paper feed direction and the first calculator computes the first amount of misalignment on the basis of the difference between the time points at which the front edge of the sheet of paper is detected by the pair of sensors.

Accordingly, since the image forming device G in accordance with this embodiment can accurately compute the first amount of misalignment of the sheet of paper, it is made possible to implement highly accurate misalignment correction.

Also, according to the image forming device G in accordance with this embodiment, the second detector detects the positions of the one end of the sheet of paper in the widthwise direction for two or more points, and the second calculator computes the second amount of misalignment of the sheet of paper on the basis of the amount of change in the positions of two or more points detected by the second detector.

Accordingly, since the image forming device G in accordance with this embodiment can accurately compute the misalignment at the time of re-feeding by the resist roller 43, it is made possible to implement highly accurate misalignment correction.

Whilst the embodiment of the present invention has been specifically described in the foregoing, the present invention is not limited to the above-described embodiment and various modifications can be made thereto within the range where the purport of the present invention is not deviated from.

For example, when the resist roller 43 is moved in the widthwise direction parallel to the width of the sheet of paper to perform the resist oscillation process to correct the positional deviation of the sheet of paper in the widthwise direction, the sheet of paper may be misaligned in some cases (for example, a case where the misalignment correction is insufficient, a case of a front sheet of the sheet of paper on which the misalignment correction should be performed, etc.). In the resist oscillation process, the range where oscillation can take place is determined assuming a state where the sheet of paper is not misaligned, so that, when the resist oscillation process is performed according to the read values of the deviation sensor 46 on an as-is basis, there may be a risk that oscillation may be performed out of the range where oscillation can take place. When the oscillation is performed out of the range where oscillation can take place, the sheet of paper comes into contact with the sidewall or the like of the feeding route, which raises the problem that scratches may be created on the sheet of paper.

In view of this, an amount of misalignment and an skew of the sheet of paper before the sheet of paper is made to abut on the resist roller 43 may be computed, and the range where actual oscillations can take place may be computed on the basis of the computed amount of misalignment and skew of the sheet of paper as well as the amount of deviation of the sheet of paper computed from the result of detection by the deviation sensor 46.

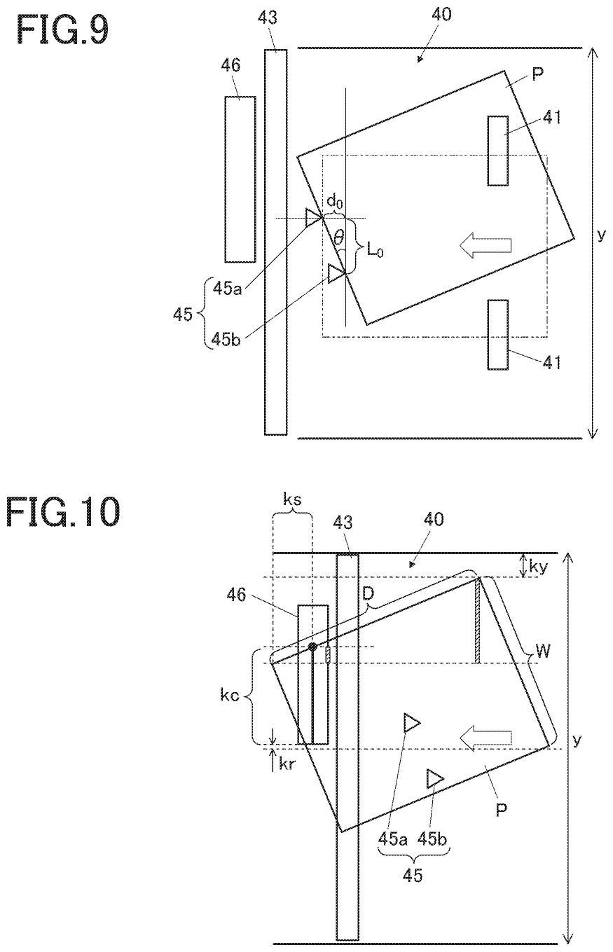

Specifically, first, the controller 11 computes, using the expression (1), the amount of misalignment d₀ and the skew θ of the sheet of paper before the sheet of paper is made to abut on the resist roller 43. It should be noted that L₀ represents the distance (see FIG. 9) between the pair of misalignment sensors 45, ΔT represents the difference between the time points at which the front edge of the sheet of paper is detected by the pair of misalignment sensors 45 (the times of passage of the pair of misalignment sensors 45), and Va represents the speed of feeding of the sheet of paper.

tan θ=d₀/L₀=(ΔT×Va)/L₀ (1)

Next, the controller 11 computes, using the expression (2), the range ky where actual oscillation can take place. It should be noted that, as illustrated in FIG. 10, y represents the width of the feeding route, kc is a value read by the deviation sensor 46, kr is the distance from the center of the feeding route to the first bit (the end on the center side of the feeding route) of the deviation sensor 46, ks represents the distance from the front edge of the sheet of paper to the position at which the detection by the deviation sensor 46 is started, D represents the length of the sheet of paper in the paper feed direction (the length of the sheet of paper), and W represents the length of the sheet of paper in the widthwise direction (width of the sheet of paper).

ky=y/2−(kc+kr)−(D*sin θ−ks*cos θ) (2)

With the above-described process, the range ky where actual oscillation can take place can be computed. As a result of this, the amount of oscillation of the resist roller 43 can be adjusted such that the sheet of paper does not touch the side of the feeding route of the sheet of paper.

Also, the controller 11 may be configured to function as a determination unit that determines whether or not the amount of misalignment M1 that has been computed in the step S104 exceeds a first upper limit value. Here, the first upper limit value refers to a value defining the envelope in which misalignment can be corrected completely. That is, in a case where the amount of misalignment M1 exceeds the first upper limit value, it can be appreciated that the misalignment cannot be completely corrected.

In this manner, by providing a determination unit (controller 11) that determines whether or not the first amount of misalignment exceeds the first upper limit value, it is made possible to determine whether or not the misalignment can be completely corrected, so that the user is allowed to flexibly select the subsequent processes depending on the situation.

For example, the controller 11 may be configured to function as a notification controller that causes a notification unit to notify of the fact that an abnormal state (waste or spoiled sheet) is entered in a case where it has been determined that the amount of misalignment M1 that has been computed in the step S104 exceeds the first upper limit value. In this case, as the notification unit, a display unit 14, a not-shown audio output unit, and the like may be mentioned. According to the above-descried feature, it is made possible to notify a user of the fact that an abnormal state (waste or spoiled sheet) is entered by a display unit 14, a not-shown audio output unit, or the like in a case where the amount of misalignment M1 exceeds the first upper limit value.

In this manner, in a case where it has been determined by the determination unit that the first amount of misalignment exceeds the first upper limit value, by providing the notification controller (controller 11) that causes the notification unit (display unit 14, etc.) to notify of the fact that the abnormal state is entered, it is made possible to notify the user of the fact that misalignment cannot be corrected completely, which makes it possible to stop image formation according to a decision by the user, which in turn makes it possible to suppress degradation of the accuracy of the positions of images and image errors.

Also, in a case where it has been determined that the amount of misalignment M1 that has been computed in the step S104 does not exceed the first upper limit value, the controller 11 may be configured to function as an oscillation controller that computes the amount of oscillation of the resist roller 43 on the basis of the position of the one end of the sheet of paper in the widthwise direction that has been detected by the deviation sensor 46 and causes the resist roller 43 to be oscillated in the widthwise direction of the sheet of paper on the basis of the computed amount of oscillation.

In this manner, the oscillation controller (controller 11) is provided that computes the amount of oscillation of the resist roller 43 on the basis of the position of the one end of the sheet of paper in the widthwise direction that has been detected by the second detector in the case where it has been determined by the determination unit that the first amount of misalignment does not exceed the first upper limit value, and causes the resist roller 43 to be oscillated in the widthwise direction of the sheet of paper on the basis of the computed amount of oscillation, and it is thus made possible to perform the resist oscillation process in a case where the misalignment can be corrected, so that the positional deviation of the sheet of paper in the widthwise direction can be corrected with no oscillation taking place out of the range where oscillation can take place.

Also, in the case where it has been determined that the computed amount of oscillation exceeds the second upper limit value which is an upper limit value that allows oscillation of the resist roller 43, the oscillation of the resist roller 43 may not be performed, or the amount of oscillation may be clamped to the second upper limit value. Here, the upper limit value that allows oscillation refers to the range ky where actual oscillation can take place computed using the above-described expression (1) and the expression (2).

In this manner, in the case where the oscillation controller has determined that the computed amount of oscillation exceeds the second upper limit value which is an upper limit value that allows oscillation of the resist roller 43, by not performing the oscillation of the resist roller 43 or clamping the amount of oscillation to the second upper limit value, no oscillation will be performed out of the range where the oscillation can take place, so that it is made possible to suppress creation of scratches on the sheet of paper due to contact with the sidewall or the like on the feeding route.

Also, the second upper limit value may be changed to a higher value in the case where it has been determined that the computed amount of oscillation exceeds the second upper limit value.

In this manner, by changing the second upper limit value to a higher value when the oscillation controller has determined that the computed amount of oscillation exceeds the second upper limit value which is an upper limit value that allows oscillation of the resist roller 43, it is made possible to make effective use of the margin from the range where oscillation can take place to the sidewall in a case where an oscillation is performed out of the range where oscillation can take place, which in turn makes it possible to more effectively and reliably correct the positional deviation of the sheet of paper in the widthwise direction.

Also, in the above-described embodiment, a configuration is described and illustrated in which a pair of reflective sensors are provided as the misalignment sensor 45, but the present invention is not limited to this configuration. For example, it is also possible to adopt a configuration where one single line sensor is provided instead of providing a pair of reflective sensors.

In this manner, since the number of parts and components can be reduced by configuring the first detector as a line sensor, it is made possible to suppress an increase in the complexity of a device and/or processing as well as an increase in costs associated therewith.

In addition, with regard to the details of the features of the individual devices constituting the image forming device as well as the details of operation of these devices, various modifications can be made thereto within the range the purport of the present invention is not deviated from.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-132841, filed on Jul. 13, 2018, is incorporated herein by reference in its entirety.

What is claimed is:

1. An image forming device including an image forming unit that forms an image on a sheet of paper, the device comprising:
a resist roller that feeds the sheet of paper toward the image forming unit;
a first detector that detects a front edge of the sheet of paper, the first detector being arranged upstream of the resist roller in a paper feed direction;
a first calculator that computes a first amount of misalignment of the sheet of paper on the basis of a result of detection by the first detector;
a corrector that corrects misalignment of the sheet of paper on the basis of the first amount of misalignment computed by the first calculator;
a second detector that detects a position of an end of the sheet of paper in a widthwise direction parallel to a width of the sheet of paper, the second detector being arranged downstream of the resist roller in the paper feed direction;
a second calculator that computes a second amount of misalignment of the sheet of paper on the basis of a result of detection by the second detector; and
an adjuster that adjusts an amount of correction by the corrector on the basis of the second amount of misalignment computed by the second calculator.

2. The image forming device according to claim 1, wherein the corrector corrects the misalignment of the sheet of paper by controlling a pair of feed rollers arranged next to each other in a direction orthogonal to the paper feed direction and arranged upstream of the first detector in the paper feed direction such that a difference in speed is created between the pair of feed rollers.

3. The image forming device according to claim 1, wherein the first detector has a pair of sensors arranged next to each other in a direction orthogonal to the paper feed direction, and
the first calculator computes the first amount of misalignment on the basis of a difference in time points at which the front edge of the sheet of paper is detected by the pair of sensors.

4. The image forming device according to claim 1, wherein the second detector detects two or more points of position of an end of the sheet of paper in the widthwise direction, and
the second calculator computes the second amount of misalignment of the sheet of paper on the basis of an amount of change in the positions of two or more points detected by the second detector.

5. The image forming device according to claim 1, further comprising a determination unit that determines whether or not the first amount of misalignment exceeds a first upper limit value.

6. The image forming device according to claim 5, further comprising a hardware processor that causes a notification unit to issue a notification indicating an abnormal state in response to the determination unit determining that the first amount of misalignment exceeds the first upper limit value.

7. The image forming device according to claim 5, further comprising a hardware processor that computes an amount of oscillation of the resist roller on the basis of a position of an end of the sheet of paper in the widthwise direction detected by the second detector in response to the determination unit determining that the first amount of misalignment does not exceed the first upper limit value, and causes the resist roller to be oscillated in the widthwise direction of the sheet of paper on the basis of the computed amount of oscillation.

8. The image forming device according to claim 7, wherein the hardware processor ensures that oscillation of the resist roller is not performed or clamps the amount of oscillation to the second upper limit value in response to the computed amount of oscillation being determined as exceeding a second upper limit value, the second upper limit value being an upper limit value that allows oscillation of the resist roller.

9. The image forming device according to claim 7, wherein the hardware processor changes the second upper limit value to a higher value in response to the computed amount of oscillation being determined as exceeding a second upper limit value, the second upper limit value being an upper limit value that allows oscillation of the resist roller.

10. The image forming device according to claim 1, wherein the first detector is a line sensor.

11. A misalignment correction method in an image forming device including an image forming unit forming an image on a sheet of paper, the method comprising:
computing a first amount of misalignment of the sheet of paper on the basis of a result of detection by a first detector that is arranged upstream, in a paper feed direction, of a resist roller feeding the sheet of paper toward the image forming unit and detects a front edge of the sheet of paper;
correcting misalignment of the sheet of paper on the basis of the computed first amount of misalignment;
computing a second amount of misalignment of the sheet of paper on the basis of a result of detection by a second detector that is arranged downstream of the resist roller in the paper feed direction and detects a position of an end of the sheet of paper in the widthwise direction; and
adjusting an amount of correction of the misalignment of the sheet of paper on the basis of the computed second amount of misalignment.
